(19) United States
(12) Patent Application Publication
(10) Pub. No.: US 2019/0011640 A1
(43) Pub. Date: Jan. 10, 2019

(54) FIBER CONNECTING DEVICE WITH MECHANICAL ELEMENT AND INTEGRATED FIBER SENSOR, FIBER CONNECTING DEVICE MODULE, AND METHOD OF CONNECTING TWO FIBERS

(71) Applicant: Corning Research & Development Corporation, Corning, NY (US)

(72) Inventors: Lisong Cao, Jiangsu (CN); Rutesh D. Parikh, Austin, TX (US); James B. Carpenter, Austin, TX (US)

(73) Assignee: Corning Research & Development Corporation, Corning, NY (US)

(21) Appl. No.: 15/762,281

(22) PCT Filed: Oct. 12, 2015
(86) PCT No.: PCT/CN2015/091701

§ 371 Date: Mar. 22, 2018

(51) Int. Cl. G02B 6/38; G02B 6/36

(52) U.S. Cl. CPC G02B 6/3806; G02B 6/3636; G02B 6/3849; G02B 6/3887; G02B 6/3846; G02B 6/3873; G02B 6/3893; G02B 6/3858

(57) ABSTRACT

Fiber connecting devices (100) are described that include a mechanical element (160) that may be opened and closed a plurality of times using an actuation mechanism (150, 150′), where the mechanism (150, 150′) allows for securing of the glass portions (56, 56′) of two optical fibers (50, 50′) at the same or different times, and allows for connection of the optical fibers (50, 50′). Methods of connecting two optical fibers (50, 50′) using such a device (100) are also described.

### FIELD

The present description relates to a mechanical element with an integrated optical sensor, as well as a mechanical optical fiber connecting device utilizing said element. Specifically, the exemplary mechanical element includes a fiber stub having a sensor element, wherein the mechanical element is configured so that two bare optical fibers can be optically coupled to said fiber stub.

### BACKGROUND

With increasing use of mobile devices, the demand for high speed access to voice, video and data is increasing, resulting in the need for data centers to transition from copper based communication lines to higher speed optical communication lines. Many of today's copper access networks are being replaced by fiber networks in order to meet the ever increasing demand of bandwidth. Monitoring of these fiber networks is essential in order to assure quality of service and allow common use of one network by different service providers.

Expansion of passive optical networks (PON), where the signal on a single optical fiber is split into separate fibers to run to each subscriber, has triggered the need for cost-effective testing. One technique for testing fiber optic links from a remote location is to send a signal down the fiber and observe reflective events. For example, an established method for this task is the so-called OTDR technology which uses a test head in the central office and test reflectors at each customer premise. To prevent the interruption of service, light whose wavelength is different from that of the communication light is used for testing. In a single fiber, the time of flight and reflected power provides information about the quality of the fiber path. In a PON system the light is split and travels independently down each branch. The resulting back-reflected light is a conglomeration of all the legs and analyzing the quality of the individual transmission lines is difficult.

Single fiber terminations can be used across the network to interconnect optical fibers. Commonly, in one conventional single fiber connection systems two male connectors (e.g., SC or LC format optical fiber connectors), and a corresponding adapter are used to interconnect a pair of optical fibers. Standard ferrule based optical fiber connectors require several precision components (e.g., springs, ferrules, housings, shrouds, and the like) that may result in a higher cost termination solution because these connectors can require more tools, skill and time to install in the field.

The optical fiber connectors can be factory or field terminated depending on the type of connectors being used. Factory mounted connectors are typically prepared in a clean room with specialized tooling that may not be available in the field. More recently, field terminated optical connectors having a factory prepared and installed fiber stub and a mechanical splice element for aligning the field prepared end of an optical fiber to the factory prepared fiber stub have simplified installation procedures so that optical connectors are easier to use in the field, but are generally designed for a single fiber termination and requires two optical connectors and an adapter to make an optical connection. An index matching gel may be used as a coupling medium to fill the gap between the ends of the field fiber and the fiber stub. The index of refraction of conventional index matching gels may change as a function of temperature causing fluctuations in optical return loss.

Another means of connecting optical fibers is to use a mechanical splice device where the optical fibers are inserted from opposite ends of the element and their end faces contact one another at approximately the center of the element. Mechanical splice devices generally use index matching gel materials in the gap between the ends of the optical fibers being spliced. U.S. Pat. No. 5,812,718 teaches fiber preparation techniques to enable splicing in a mechanical element without the need for an index matching gel. Beveling the ends of the optical fibers being joined reduces undesirable defects caused by cleaving.

Conventional reflector solutions for monitoring solutions exist that can either be implemented inside an optical connector or used as a stand-alone component. One type uses fiber Bragg gratings. Alternatively, thin film filter solutions are described in which discrete filter elements are inserted in the optical path. For example, see U.S. Pat. No. 5,037,180; JP 11-231139; and EP 2264420. However, these solutions have the disadvantage of being cost intensive due to complex production processes and can require special packaging in the case of a stand-alone component to protect reflective elements.

Thus, there is a need for a cost effective connection system that includes a reflective element for monitoring applications.

### SUMMARY

In a first embodiment, the present description relates to an optical fiber connecting device for housing a mechanical element for aligning, gripping, and connecting first and second optical fibers. Each optical fiber includes a bare glass portion surrounded by a buffer layer. The device includes a housing configured to contain a mechanical element disposed therein. An integrated optical fiber sensor is at least partially disposed in the mechanical element so that the mechanical element optically will connect at least one of the first and second optical fibers to the integrated optical fiber sensor. An actuation mechanism is disposed adjacent to the mechanical element. The actuation mechanism opens and closes the mechanical element a plurality of times, and allows for the first and second optical fibers to be positioned, secured and actuated in the mechanical element at the same or different times.

In one aspect, the integrated optical fiber sensor is a fiber stub having at least one sensor element, wherein the at least one sensor element is one of a fiber Bragg grating, a thin film reflective filter and a combination thereof.

In another aspect, the mechanical element comprises a first gripping section, a second gripping section, and a fiber stub holding section disposed between the first gripping section and the second gripping section. The fiber stub extends through the fiber stub holding section and partially into the first and second gripping sections such that the bare glass portion of the first optical fiber connects to the first end of the fiber stub in the first gripping section and the bare glass portion of the second optical fiber connects to the second end of the fiber stub in the second gripping section. A first actuation mechanism is positioned over the first gripping section of the mechanical element to open and close the first gripping section repeatably and independently of the second gripping section, and a second actuation mechanism positioned over the second gripping section of the mechanical element to open and close the second gripping section repeatably and independently of the first gripping section.

In yet another aspect, the optical fiber connecting device comprises a first mechanical element and a second mechanical element wherein the fiber stub extends partially into each of the first and second mechanical elements and wherein the bare glass portion of the first optical fiber connects to the first end of the fiber stub in the first mechanical element and the bare glass portion of the second optical fiber connects to the second end of the fiber stub in the second mechanical element. A first actuation mechanism positioned over the first mechanical element to open and close the first mechanical element repeatably and independently of the second mechanical element, and a second actuation mechanism positioned over the second mechanical element to open and close the second mechanical element repeatably and independently of the first mechanical element.

A plurality of the exemplary optical fiber connecting devices can be assembled together to create an optical fiber connecting device module that is configured to interconnect the bare glass portions of a plurality of first and second optical fibers.

In a second embodiment, the present description relates to an optical fiber connecting device module for interconnecting bare glass portions of a plurality of first and second optical fibers. The module includes a plurality of first mechanical elements arranged parallel to one another in a side-by-side arrangement; a plurality of integrated optical fiber sensors at least partially disposed in the first mechanical elements, wherein each of the first mechanical elements optically connects at least one of the first and second optical fibers to the integrated optical fiber sensor, and a plurality of actuation mechanisms that can actuate the plurality of first mechanical elements to allow for the first and second optical fibers to be positioned, secured and actuated in the optical fiber connecting device at the same or different times.

In a third embodiment, a method is disclosed for connecting a first and a second optical fiber with an exemplary optical fiber connecting devices of the present invention. A first optical is prepares to expose the bare glass portion at a terminal end thereof. The bare glass portion is slid into exemplary optical fiber connecting device and into a first end of a mechanical element until it presses against a first end of an optical fiber stub disposed at least partially within the mechanical element. The first optical fiber is locked in the mechanical element by activating a first actuation mechanism. This set of steps can be done in the factory to create a preterminated optical fiber or it can be done in the field during installation of the network. Later, the second optical fiber can be connected to the exemplary optical fiber connecting device by first preparing the second optical fiber to expose the bare glass portion at the terminal end thereof. This bare glass portion can be inserted into a second end of the mechanical element opposite the first end until it presses against a second end an optical fiber stub disposed at least partially within the mechanical element. The second optical fiber is locked in the device by activating a second actuation mechanism.

### BRIEF DESCRIPTION OF THE DRAWINGS

FIGS. 1A-1D are four views of an exemplary optical fiber connecting device according to the present invention.

FIGS. 2A-2E are five views of an exemplary mechanical element of the optical fiber connecting device of FIGS. 1A-1D.

FIGS. 3A and 3B are two cross-sectional views showing the mechanical element of the optical fiber connecting device of FIGS. 1A-1D in and open state and a closed state respectively.

FIGS. 4A-4D are four views of another exemplary optical fiber connecting device according to the present invention.

FIG. 5 is a cross sectional detail view showing the optical connection interfaces between the sensored optical fiber stub and two optical fibers being connected by the device of FIGS. 4A-4D.

FIGS. 6A and 6B are two views of a third exemplary optical fiber connecting device according to the present invention.

FIGS. 7A and 7B are two views of an exemplary optical fiber connecting device module according to the present invention.

FIG. 8 is an isometric view of another exemplary optical fiber connecting device module based on the optical fiber connecting device of FIGS. 4A-4D.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

The present invention is an optical fiber connecting device having an integrated optical fiber sensor that allows the direct reversible connection of two optical fibers with the integrated optical sensor in a small form factor device. The integrated optical sensor can be a fiber stub having at least one sensor element. In an exemplary aspect, the optical fiber connecting devices include an actuation mechanism that allows for the mechanical element to be opened and closed a plurality of times, and allows for the first and second optical fibers to be positioned, secured and actuated in the mechanical element at the same or different times.

Conventional fusion splicing is commonly used to simultaneously and permanently connect two optical fibers together. Fusion splicing requires operators to have a fusion splice machine that melts the terminal ends of the optical fibers being connector and pushes them together to create a fusion splice. Fusion splices are generally placed inside of a heat shrinkable protective tube to stabilize and protect the optical splice. Conventional mechanical splices are commonly used to simultaneously and permanently connect two optical fibers together in a quasi-permanent connection. If the connection made between the two optical fibers is faulty, the mechanical holding means can be reopened, frequently requiring an auxiliary tool, the fibers repositioned, and followed by the reactivation of the mechanical holding means. Once a good connection is made, conventional mechanical splice devices are typically permanent.

In contrast, the exemplary optical fiber connecting device of the present invention enables making a reversible optical connection overcoming short comings of conventional splicing technologies by providing a smaller form factor connection device with an integrated sensor that enables easier and reversible interconnection of two optical fibers. As mentioned previously, the integrated optical fiber sensor can be a fiber stub having at least one sensor element.

The exemplary optical fiber connecting device can be used to monitor an optical transmission line to isolate fiber faults, reducing maintenance costs and improving service reliability. The integrated sensor of the device has conventional sensor elements that can be accommodated in an optical fiber stub including fiber Bragg gratings (FBG) and/or multilayer thin film (TF) filters. Each of these elements can enable selective high reflection of a monitoring wavelength and high transmission of the data band. An optical time domain reflectometer (OTDR) can be used to monitor to transmission line for the reflected signal.

A FBG has good back reflection performance in the data band and the monitoring band, but can have large transmission loss in the data band and are sensitive to changes in the ambient temperature. A shortcoming of the FBG technology is that each FBG is fabricated on a one-by-one basis.

TF filter coatings (or TF filters) can be designed to have very low transmission loss in data band and have an extremely small footprint (<20 μm). In addition, TF filters and can be deposited onto a large number of fibers in parallel. TF filters are not temperature sensitive, but TF filters can have less than optimal back reflection performance at the data band (as compared to an FBG). Also, there can be a limit on the maximum thickness of a TF filter coating that can be deposited on optical fiber end surface.

For some applications in optical monitoring, it is beneficial to have a sensor with (a) high back reflection loss in the data band within the reflection spectrum; (b) high isolation between the data band and the monitoring wavelength within the transmission spectrum; and (c) low transmission in the data band within transmission spectrum. According to an aspect of the invention, an optical fiber having a TF filter deposited on at least one end and a FBG fabricated therein can achieve this performance criteria.

The exemplary optical fiber connecting devices can be used as a single stand-alone device, or a plurality of the exemplary devices can be combined into a module for use in fiber to the home fiber cabinets or enclosures; optical fiber wall boxes, cabinets, equipment rooms, or enclosures in premises optical networks; high density optical distribution frames in data centers or telecommunication central offices; high density patch panels in mobile switching centers, enclosures for fiber to the antenna installations and in small cell aggregation point and back haul enclosures in wireless networks.

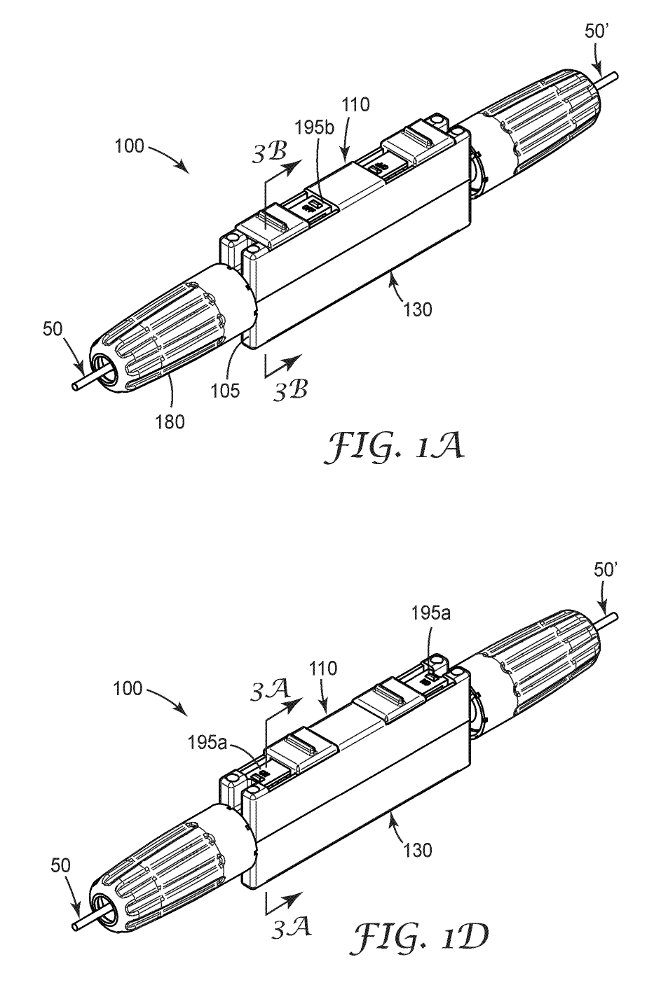

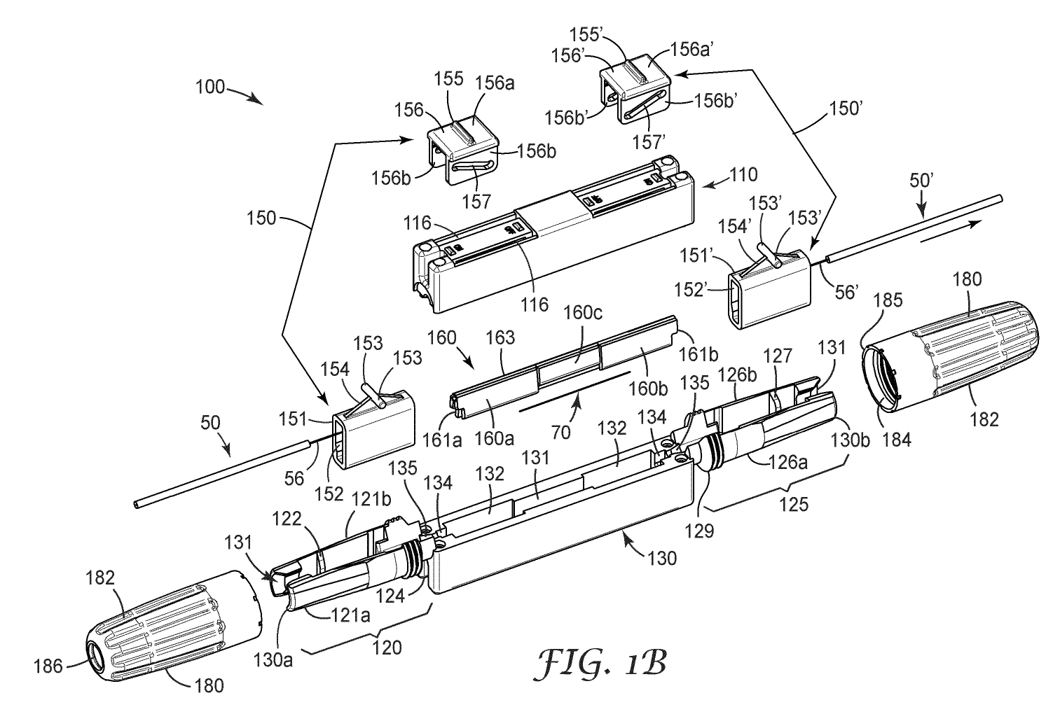

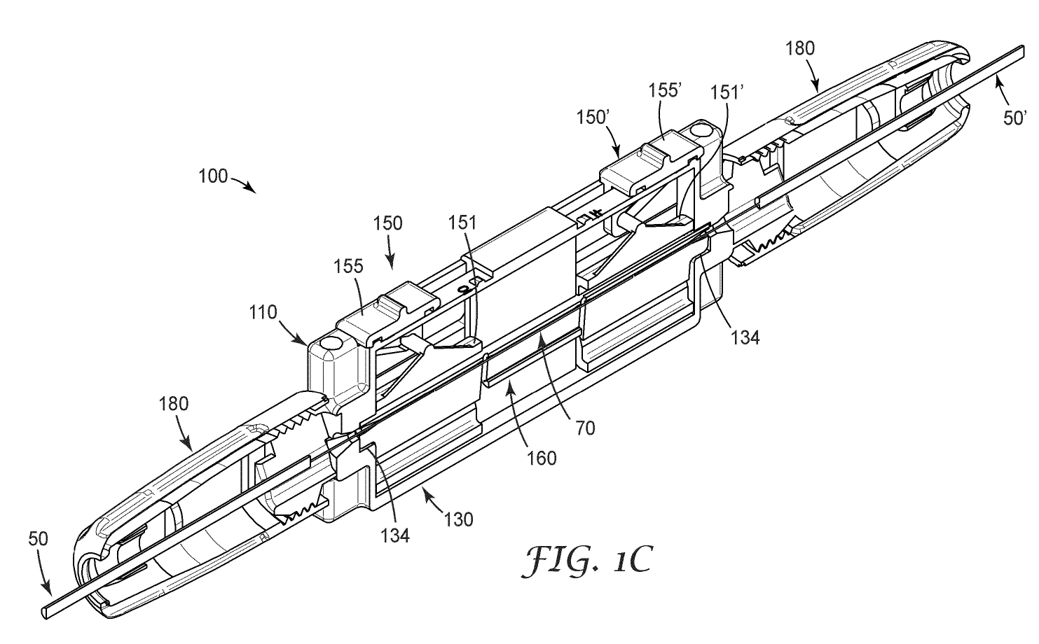

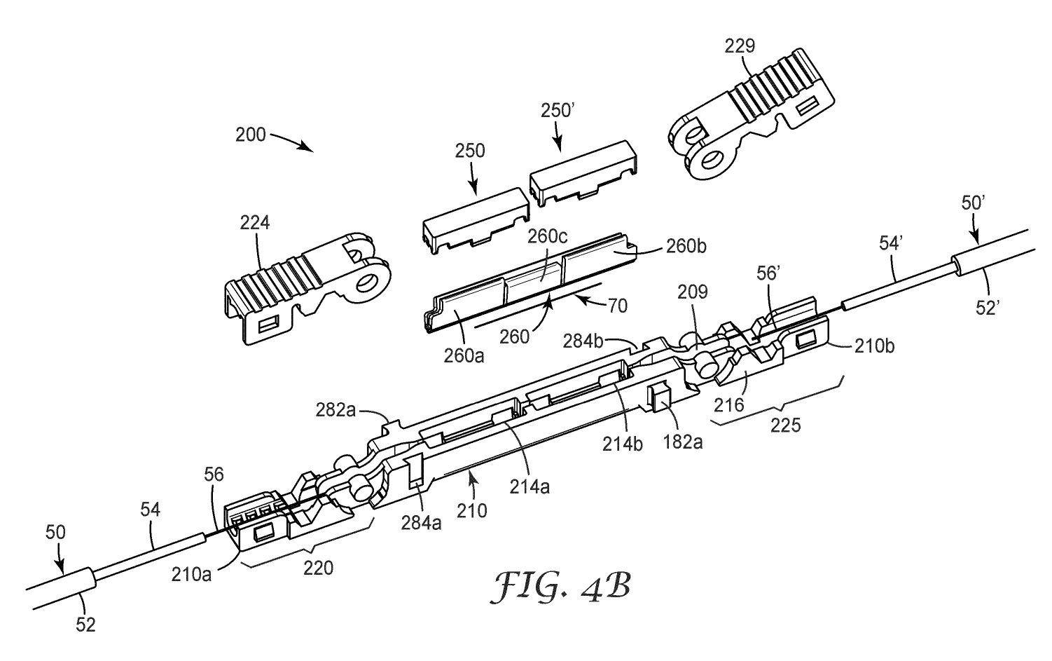

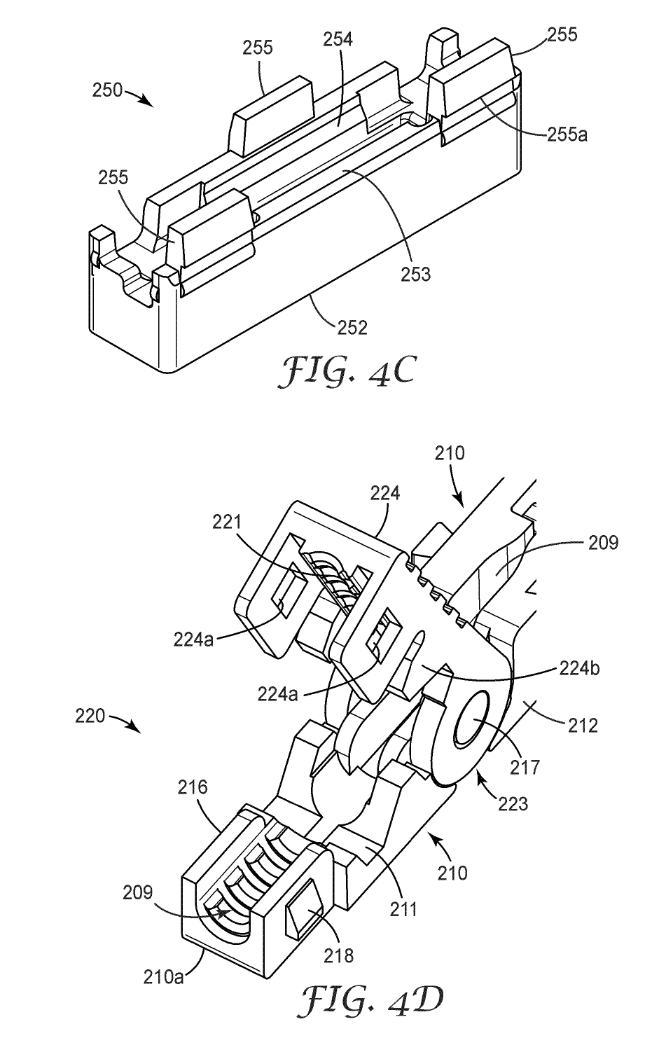

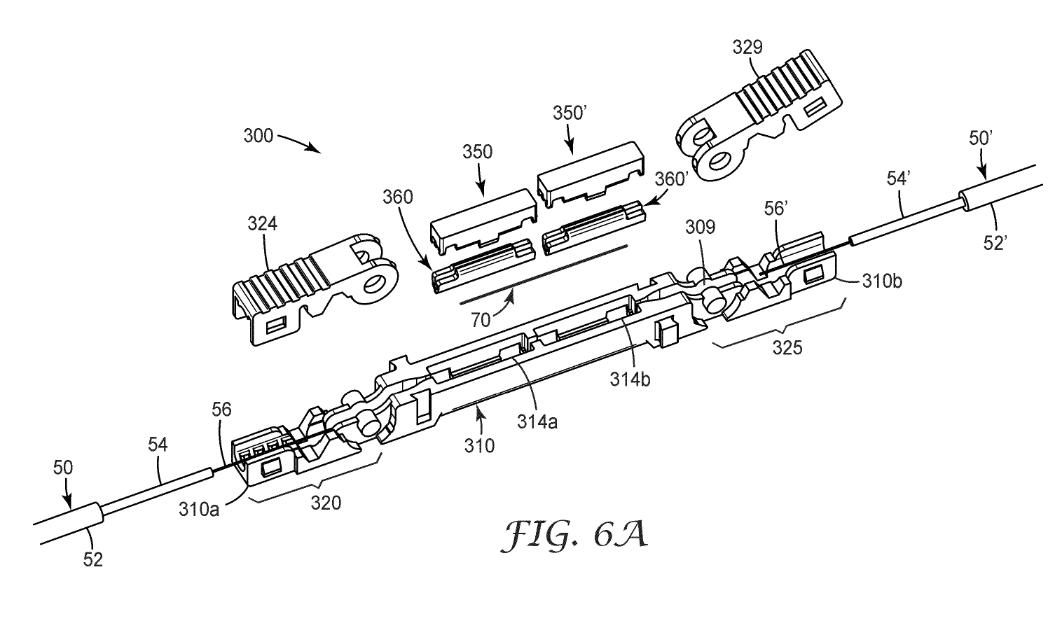

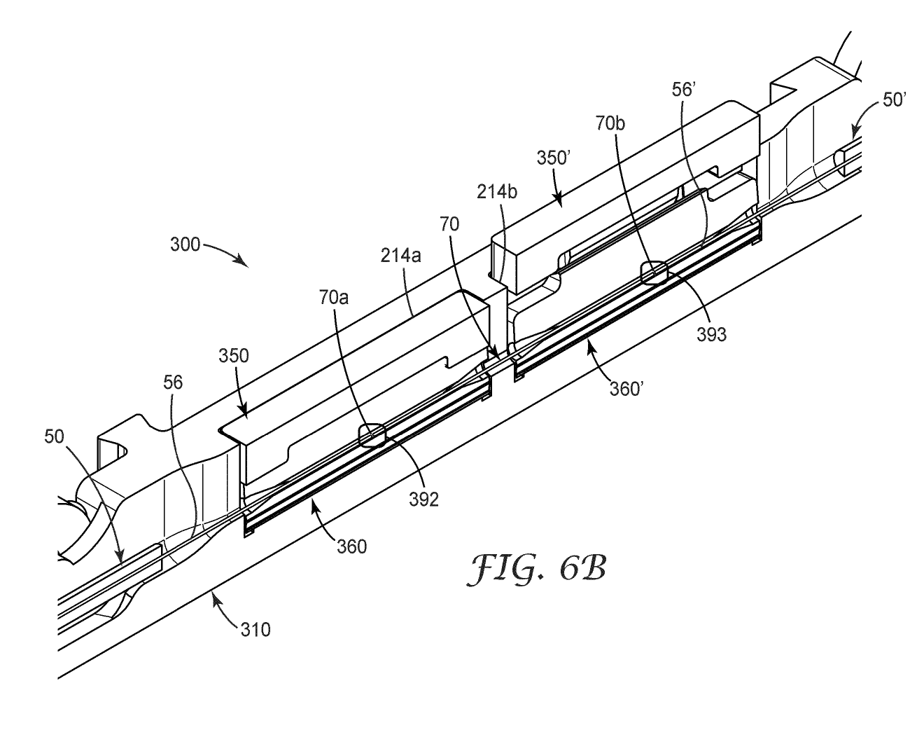

FIGS. 1A-1D show an exemplary optical fiber connecting device 100 for independently securing two optical fibers 50, 50′. Each fiber can be terminated independently. For example, the exemplary optical fiber connecting device can be factory terminated onto one of the optical fibers and the second fiber can be terminated in the field, saving the installer time. Alternatively, the exemplary optical fiber connecting device can be field installed onto one of the optical fibers during installation or expansion of an optical fiber network. The optical connection with a second optical fiber can be made at a later time. In an alternative aspect, the exemplary optical fiber device can be connected to two optical fibers simultaneously to make an optical connection. In one aspect, the first optical fiber 50 can be a portion of a first optical fiber cable, and the second optical fiber 50′ is a portion of a second optical fiber cable. The first and second optical fiber cables can each have a bare glass portion 56, 56′ (i.e. the core of the optical fiber plus the cladding that surrounds the core), at least one buffer layer 54, 54′ surrounding the bare glass portion, and a jacket 52 52′ surrounding the buffer layer as shown in FIGS. 4B and 6A.

The optical fibers 50, 50′ can be a conventional optical fiber cable such as a 250 μm or 900 μm buffer coated fiber, Kevlar® reinforced jacketed fiber, a jacketed drop cable or other sheathed and reinforced fiber. The optical fiber of the optical fiber cable can be single mode or multi-mode. Example multi-mode fibers can have a 50 μm core size, a 62.5 μm core size, or a different standard core size. In yet another aspect, the optical fiber cable can be an FRP drop cable, a 1.6 mm to 6.0 mm jacketed round drop cable, a flat drop cable, or other optical fiber drop cable. In an exemplary aspect, drop cables from a demarcation point can be connected to an indoor/outdoor type of 4.8 mm to 6 mm or approximately 3 mm fiber cable. In the exemplary aspect shown in the figures, optical fibers 50, 50′ include a bare glass portion 56, 56′ disposed within a buffer coating 54, 54′ which is disposed in an outer coating layer 52, 52′. The outer coating layer can be another buffer layer, an indoor jacket or a ruggedized outdoor jacket.

Optical fiber connecting device 100 includes a main body or housing 105 having an upper housing portion 110 and a lower housing portion 130 that can be secured together by mechanical means, such as by mechanical fasteners or by an interference fit between the upper and lower housing portions. Alternatively, the housing portions can be bonded together by, for example, an adhesive or by ultrasonic welding.

The upper housing portion 110 and a lower housing portion are configured to contain a mechanical element 160. The first and second actuation mechanisms can have virtually the same structure. The first and second actuation mechanisms allow the first end 161a and the second end 161b of the mechanical element to be actuated separately. The mechanical element can be opened and closed a plurality of times by the actuation mechanism allowing the first and second optical fibers to be positioned, secured and actuated in the mechanical element at the same or different times.

Lower housing portion 130 has a first end 130a and a second end 130b and a channel 131 extending longitudinally through the lower housing portion from a first end of the second end to guide the optical fibers being connected within optical connecting device 100. The lower housing can include a first clamping portion adjacent to the first end of the lower housing portion, a second clamping portion adjacent to the second end of the lower housing portion and a connection portion disposed between the first and second clamping portions. Channel 131 extends through the first clamping portion, the connection portion and the second clamping portion.

The connection portion of the lower housing portion includes at least one cavity 132 formed along the channel within the lower housing portion. In the exemplary embodiment shown in FIG. 1B, the lower housing portion includes two cavities formed along the centerline of the channel. Each cavity is configured to house at least a portion of the actuation mechanism 150 and a portion of the mechanical element. Half funnel guide structures 135 are formed in the channel on either side of the connection portion to facilitate guiding the bare glass portions of the optical fibers into the mechanical element. An element holding notch 134 is formed at each end of the connection portion where the channel enters the connection portion. There are corresponding half funnel guides and element holding notches forms in the upper housing portion that cooperate with the half funnel guides and element holding notches in the lower housing portion to make a complete funnel guide structure and hold the mechanical element within the connection portion of the exemplary optical fiber connecting device when the upper and lower housing portions are secured together.

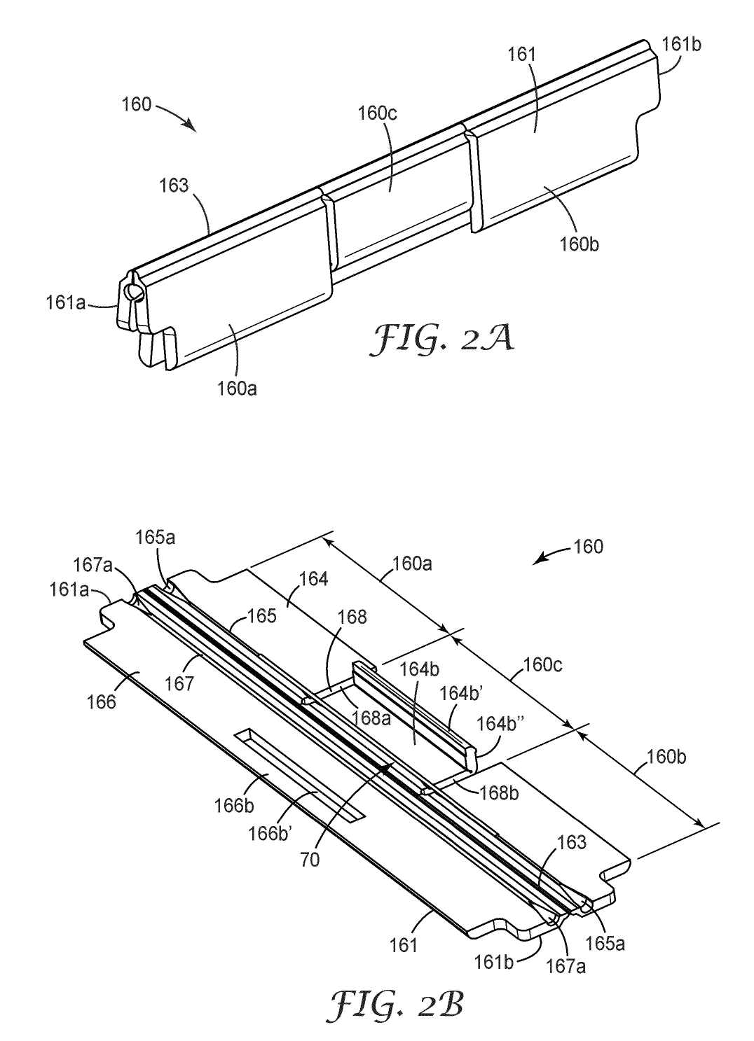

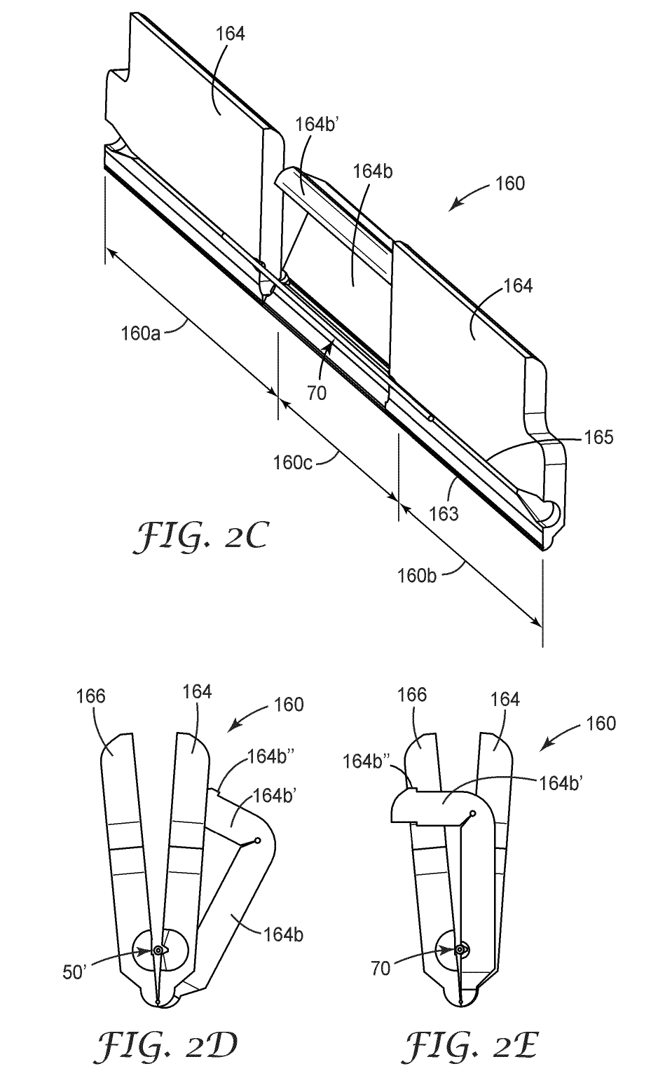

FIGS. 2A-2E are detail views of mechanical element 160. Mechanical element 160 includes a body, such as a sheet 161, having a first gripping section 160a and second gripping section 160b located on opposite ends of the body, and a fiber stub holding section 160c located between the first and second gripping sections. Not only do the first and second gripping sections secure the first and second optical fibers but they also ensure alignment between the active portions (i.e. the cores) of the first and second optical portions with the core of the fiber stub. Sheet 161 can be folded in half longitudinally along hinge 163 that separates the sheet into two identical plate-like members 164, 166.

Fiber receiving channels 165, 167 are formed on the inside surface of each of the plate-like members, respectively. In an exemplary aspect, the fiber receiving channels can be in the form of a V-groove that is stamped, embossed or otherwise formed in the sheet 161 prior to folding of the sheet into mechanical element 160. The fiber receiving channels extend longitudinally along the length of the mechanical element and are generally parallel to the focus hinge. The open top of the fiber receiving channels face each other in the folded mechanical element. It should be noted that it is not necessary for the V-grooves to have a sharp angle in order to be considered V-shaped; given the small dimensions involved, the apex of the “V” may be somewhat curved or even flattened out, but the overall shape is still generally that of a “V”.

Each fiber receiving channel 165, 167 can include cone shaped guides 165a, 167a at each of the fiber receiving channels to facilitate insertion of the first and second optical fibers into the mechanical element.

Sheet material 161 should be sufficiently deformable so that it can partially conform to the surface of optical fiber. In addition to improved signal transmission, this also results in greater fiber retention and facilitates splicing of two fibers to the internal fiber stub. The sheet material 161 may be selected from a variety of ductile metals, such as soft aluminum or aluminum alloys. Other metals, alloys, or laminates thereof, may be used in the construction of the sheet including copper, tin, zinc, lead, indium, gold and alloys thereof.

The mechanical element can receive the bare glass portions of the first and second optical fibers, 50 and 50′, as shown in FIG. 1C are butted against each end of a fiber stub 70 secured in the a fiber stub holding section.

Referring again to FIGS. 2A-2E, the dimensions of sheet 161, especially the length of the sheet, may vary considerably depending upon the application and the type of sensing fiber stub to be held within the mechanical element, the following dimensions are considered exemplary and are not to be construed in a limiting sense. The fiber stubs can vary in length from about 10 mm to about 25 mm depending if the sensor element of the fiber stub is one or more short fiber Bragg gratings written into the core of the fiber stub, a multilayer thin film filter formed on at least one end of the fiber stub, a partially transmissive mirror surface coated on at least one end of the fiber stub or a combination thereof. Bragg gratings can be written into the stub fiber utilizing conventional Bragg grating technology. TF filters can be deposited onto at least one end of the fiber stub via a batch deposition process. Alternatively, the TF may be formed on only a portion of the end of the fiber stub as described in commonly owned U.S. Provisional Patent Application No. 62/174,719, incorporated herein by reference in its entirety.

In an exemplary aspect, the ends of the fiber stub can be beveled or chamfered to improve the core contact area between the stub and the first and second optical fibers.

The size of sheet 161 can be about 25 mm to about 40 mm long by about 8 mm to about 14 mm wide along the major edges. The fiber receiving channels 165,167 can be placed about 0.9 mm from the fold line of the hinge 163 and the fiber receiving channels can have a maximum width of about 129 μm.

As mentioned previously, mechanical element 160 includes first gripping section 160a, second gripping section 160b, and a fiber stub holding section 160c located between the first and second gripping sections. Each of these sections can be actuated separately and are defined by slots 168 formed through at least one of the plate-like members and perpendicular to the fiber receiving channels. In particular, mechanical element 160 has two slots 168a, 168b (collectively slots 168). Slot 168a is disposed between first gripping section 160a and the fiber stub holding section 160c, while slot 168b is disposed between the fiber stub holding section and the second gripping section 160b.

In an exemplary aspect, fiber stub 70 is positioned in mechanical element 160 such that a first end of the fiber stub is disposed in the first gripping section 160a, and the second end of the fiber stub is positioned in the second gripping section 160b as shown in FIGS. 2A and 2B, wherein the fiber stub holding section clamps on to the central portion of the fiber stub to secure the fiber stub in the mechanical element. The fiber stub is permanently secured in the mechanical element in the factory. To accomplish this, the fiber stub holding section includes locking means. For example, the portion 164b of plate-like member 164 of the fiber stub holding section can have a folded flange 164b′ that can be inserted through opening 166b′ formed through portion 166b of plate-like member 166 of the fiber stub holding section. In one aspect, the folded flange can have a lip 164b″ that engages with the edge of opening 166b′ to secure the fiber stub holding section around the fiber stub, locking the fiber stub in the mechanical element. In another aspect, the folded flange can be inserted through opening 166b′ and crimped to lock the fiber stub in the mechanical element. In some embodiments, an index matching gel can be disposed in the first and second gripping sections adjacent to the ends of the fiber stub to improve performance.

The fiber gripping sections 160a, 160b of mechanical element can be actuated in either the factory and/or the field. Referring back to FIGS. 1A-1D, the unique structure of optical fiber connecting device 100 allow the fiber gripping sections to be opened and closed independently and reversibly by the built in actuation mechanisms 150, 150′. Exemplary optical fiber connecting device includes a main body or housing 105 having an upper housing portion 110 and a lower housing portion 130 that can be secured together by catch or latch features (not shown) disposed on the upper and lower housing portions. The upper and lower housing portions are configured to contain a mechanical element 160 and actuation mechanisms 150, 150′ that enable opening and closing of the first and second gripping sections 160a, 160b of mechanical element 160, respectively. The actuation mechanisms are in the form of a sliding switch. Each actuation mechanism 150, 150′ comprises an actuation sleeve 151, 151′ that can be repeatedly moved by an actuation element to open and close the gripping sections of the mechanical element 160 that is at least partially disposed in a passageway 152, 152′ extending through each actuation sleeve. In the present aspect, the alignment sleeve can have a shape of a generally rectangular prism.

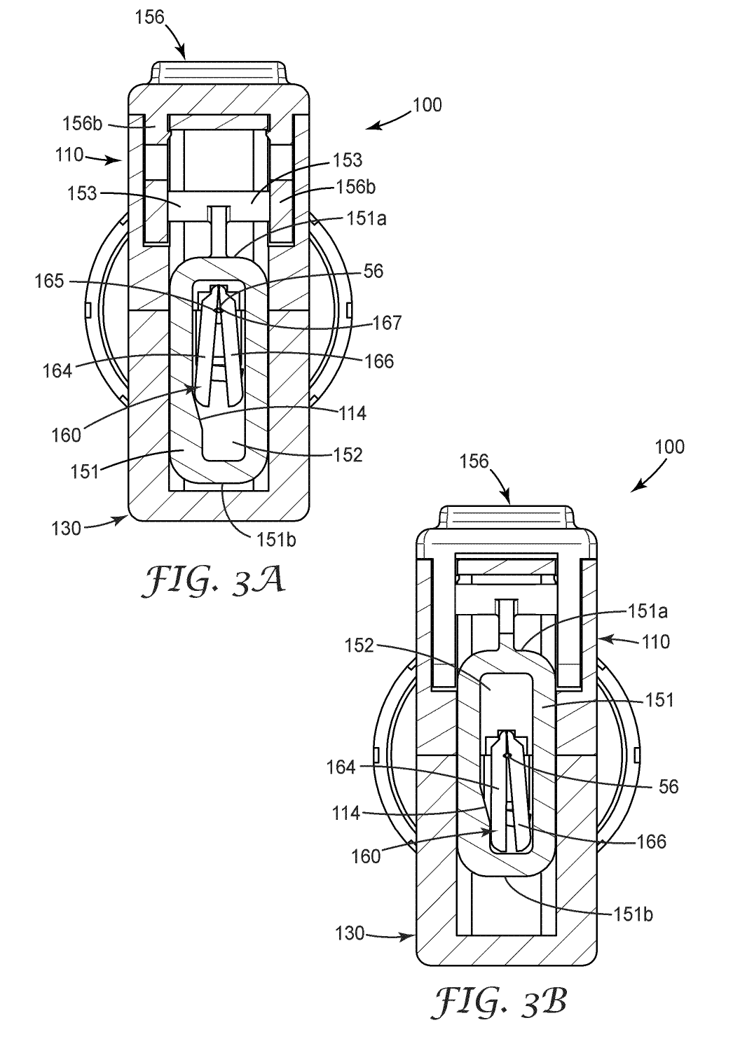

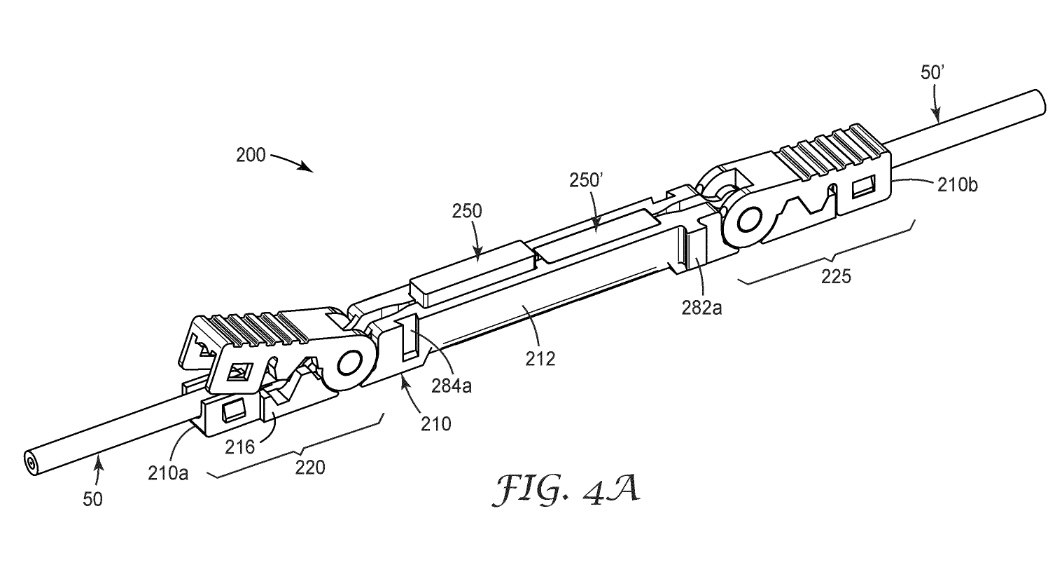

Passageway 152 through the actuation sleeve 151 has a variable width along an axis extending between the top wall 151a and bottom wall 151b as shown in FIGS. 3A and 3B. The side walls of the passage way provide a cam surface 114. The cam surfaces on the interior side walls of the passageway have a first portion near the bottom wall of the actuation sleeve that are closer to each other than at a second portion of the cam surfaces. There is a sloped transition portion between the first and second portions of the cam surface to aid the actuation sleeve in sliding with respect to the mechanical element 160 when actuated. FIG. 3A shows the actuation mechanism 150 disposed in a first position where the sleeve is lowered and the mechanical element is open. When the actuation sleeve is lifted, the plate-like members of the gripping portion(s) 164, 166 of the mechanical element slide along the transition portion. The transition portion pushes the legs of the gripping element towards one another other to a second or closed position to secure the bare glass portion 56 of an optical fiber passing at least partially through the gripping section of the mechanical element as shown in FIG. 3B.

The actuation mechanism also includes an actuation element that interacts with or influences the actuation sleeve 151 causing the actuation sleeve to move with respect to the mechanical element. The actuation element in this embodiment is an actuation sled 156.

Each actuation sled 156, 156′ includes an actuation platform 156a, 156a′ and a pair of extension members 156b, 156b′ extending from opposite edges of and beneath the actuation platform as shown in FIG. 1B. An inclined slot 157, 157′ is formed through each extension member 156b, 156b′ and is configured to receive the lifting pegs 153, 153′ extending from a partition 154, 154′ disposed on a top surface of the actuation sleeve. Each inline switch can include a ridge 155, 155′ formed on top of the actuation sled to facilitate actuating/de-actuating the actuation mechanism. The actuation sled can reside in a recessed portion of the top surface of the upper housing portion 110 in the assembled optical fiber connecting device. The extension members 156b, 156b′ are inserted through guide slots 116 disposed through the recessed portion of the top surface of the upper housing portion, then the lift pegs are snapped into the inclined slots on the extension members.

In an exemplary aspect, indicia 195a, 195b can be formed in the top wall of the upper housing portion 110 to indicate whether the mechanical element contained within the housing 105 of the optical fiber connecting device is open (on) or closed (off) as shown in FIGS. 1A and 1D.

While actuation mechanisms 150, 150′ are shown having the form of a sliding switch, other actuation mechanisms are possible. Exemplary alternative activation mechanisms useable in the current optical connecting device are described in US Provisional Patent Application filed on an even date herewith, entitled “Connector for Connecting Two Bare Optical Fibers”, (Attorney docket No. 76191US002), incorporated herein by reference in its entirety.

Lower housing portion 130 can further include first and second cable jacket clamping portions 120, 125 integrally formed with lower housing portion and disposed on either side of the mechanical element. Thus, the lower housing portion can be a unitary structure configured to house the mechanical element (with the upper housing portion) as well as providing the basic structure (e.g. the clamping portions) necessary to retain the first and second optical fibers 50, 50′ in the optical fiber connecting device. The first cable jacket clamping portion 120 is configured to clamp the jacketed portion of the first optical fiber cable 50 containing the first optical fiber 50 and the second cable jacket clamping portion 125 configured to clamp the jacketed portion of the second optical fiber cable containing the second optical fiber 50′. In an alternative embodiment, the first and second cable jacket clamping portions can each be configured to clamp the outer surface of a buffer tube (not shown) containing the first and second optical fibers, respectively.

In an exemplary embodiment, the first and second cable jacket clamping portions 120, 125 can have the same basic structures. For example, each of the first and second cable jacket clamping portions can have a collet-type, split body shape comprising two arms 121a, 121b and 126a, 126b that extend away from the lower housing portion 130 along a common axis. The clamping portion can include raised inner surfaces (e.g. teeth, barbs or triangular ridges, not shown) near the free end of the arms to permit ready clamping of the cable jacket portion of an optical fiber cable. Each arm can include a stop 122, 127 formed on an inner surface opposite the stop on the other arm. The stops prevent passage of a cable jacket portion of an optical fiber from being inserted further into the optical connection device.

A boot 180 can be utilized to actuate each of the clamping portions 120, 125 when secured to the optical fiber connecting device 100. In an exemplary aspect, each boot can be attached to the clamping portion by a screw-type mechanism. When working with optical fiber cables having strength members, especially Kevlar or glass floss strength members, the boots can be used to clamp the fiber strength members as well as the fiber jackets of the first and second optical fibers to improve the retention strength of the optical fiber cables in the optical fiber connecting device.

In an exemplary aspect, boot 180 includes a tapered body 182 having an axial bore throughout with threaded grooves 184 formed on an inner surface at the front opening 185, wherein the grooves are configured to engage with the correspondingly threaded mounting structure 124, 129 of the clamping portions 120, 125 extending from the lower housing portion 130. In addition, the axial length of boot is configured such that a rear section of the boot, which has a smaller opening 186 than at front opening, engages the jacket clamp portion. For example, when boot 180 is secured onto the threaded mounting structure of the lower housing portion, the axial movement of the boot relative to the lower housing portion forces the arms of clamp portion to move radially inwards so that the fiber jacket is tightly gripped between the arms of the clamping portion. Also, the strength members of the optical fiber cable can be disposed between the boot and the threaded mounting structure to secure the strength members as the boot is installed. This construction can provide a terminated optical fiber connecting device capable of surviving rougher handling and greater pull forces. In an exemplary aspect, boot 180 is formed from a rigid material. For example, one exemplary material can comprise a fiberglass reinforced polyphenylene sulfide compound.

To assemble optical fiber connecting device 100, the first gripping section 160a of mechanical element 160 is disposed in passageway 152 of the alignment sleeve 151 with the hinge 163 of the mechanical element at the top. The first gripping section 160b of the mechanical element is disposed in passageway 152′ of the alignment sleeve 151′. The mechanical element and the actuation sleeves are placed into the lower housing portion so that the ends of the mechanical element is positioned in element holding notches 134. The upper housing portion 110 is then attached to the lower housing portion 130 being sure that the ends of the mechanical element are disposed in the element holding notches (not shown) formed in the upper housing portion so that the ends of the mechanical element is held stationary between the element notches in the upper and lower housing portions. Next, the extension members 156b, 156b′ of the actuation sled are inserted through guide slots 116 disposed through the recessed portion of the top surface of the upper housing portion, and the lift pegs 153, 153 are snapped into the inclined slots on the extension members.

FIGS. 3A and 3B show a detail view of the first gripping section of mechanical element 160 in an open state and a closed state, respectively. Specifically, FIG. 3A is a cross sectional view of optical fiber connecting device 100 showing actuation sleeve 151 in a first position in which the mechanical element 160 is in an open position to allow insertion (or withdrawal) of the bare glass portion 56 of an optical fiber into or out of the mechanical element. When the actuation sled is moved from a first position to a second position, the actuation sleeve is lifted causing the plate-like members 164, 166 of the first gripping section of the mechanical element to slide along cam surface 114 of the passageway 152 pushing the legs of the gripping element towards one another other to a closed position securing the bare glass portion of the optical fiber 56 in fiber receiving channels 165, 167 of the mechanical element. This second position of the actuation sleeve where the mechanical element is in a closed position is shown in FIG. 3B. To remove one or more of the optical fibers from the mechanical element, the actuation sled is moved from the second position to the first position, causing the actuation sleeve to move down relative to the mechanical element. The plate-like members of the gripping section of the mechanical element slide along cam surface to the widest portion of the passageway, allowing the legs to spread apart opening the mechanical element so that the optical fiber positioned therein can be removed or repositioned. In this way, optical fibers can be readily connected and disconnected with this exemplary connection device.

The downward facing mechanical element (i.e. having the opening between the legs of the element disposed nearer to the lower housing portion) can prevent the accumulation of dirt/debris in the element's alignment groove. In some embodiments of the invention, an index matching gel (not shown) can be disposed in the mechanical element at the point where the bare glass portions of the first and second optical fibers will ultimately reside upon actuation of the mechanical element.

To terminate the first and/or the second optical fibers in optical fiber connecting device 100, the actuation sled 156 is moved to a first position, shown in FIGS. 1A and 3A opening the mechanical element 160. Boot 180 is slipped over a stripped and cleaved end of the first optical fiber 50 being terminated. A bare glass portion at the terminal end of said optical fiber is inserted into the device so that it is guided into the first gripping section of the mechanical element. The first fiber is pushed in until a resistance force is felt through the fiber which is a result of the end of the first fiber butting up against a first end of the fiber stub disposed within the mechanical element. The actuation sled is pushed to a second position as shown in FIGS. 1D and 3B lifting the alignment sleeve 151 and closing the first gripping section of the mechanical element around the bare glass portion of the first fiber. The boot is attached over the clamping portion to secure the device to the jacket of the optical fiber. When the second optical fiber needs to be connected, the procedure is repeated.

The downward facing mechanical element (i.e. having the opening between the legs of the element disposed nearer to the lower housing portion) may prevent the accumulation of dirt/debris in the element's alignment groove. In some embodiments of the invention, an index matching gel (not shown) can be disposed in the mechanical element at the point where the bare glass portions of the first and second optical fibers will ultimately reside upon actuation of the mechanical element.

Exemplary connecting device 100 is a new form of connecting device that allows direct reversible connection of two optical fibers in a single device. The ability to move the actuation mechanism from a first position to a second position allows the mechanical element to be open and closed allowing the connection and disconnection of the first and second optical fibers. Thus connecting device 100 can be considered an optical fiber connector with an integrated sensor.

FIGS. 4A-4D show an alternative exemplary optical fiber connecting device 200 for independently securing two optical fibers 50, 50′ to a sensored fiber stub housed within the connecting device. Each fiber can be terminated independently, allowing the exemplary optical fiber connecting device to be factory terminated onto one of the optical fibers saving the installer time, or the connecting device can be installed onto one of the optical fibers during installation or expansion of an optical fiber network of installation. The optical connection with a second optical fiber can be made at a later time. In an alternative aspect, the exemplary optical fiber device can be connected to two optical fibers simultaneously to make an optical connection.

Optical fiber connecting device 200 includes a housing 210 that holds a mechanical element 260 to axially align and grip the bare glass portions of two optical fibers with a sensored fiber stub disposed within the mechanical element and a pair of actuation elements in the form of actuating caps 250, 250′. The actuating caps are configured to actuate the gripping portions 260a, 260b of the mechanical element. Mechanical element 260 is analogous to mechanical element 160 shown in FIGS. 2A-2E.

Housing 210 has a main body 212 having a first end 210a and a second end 210b and a channel 209 extending longitudinally through the main body from a first end of the main body to a second end of the main body to guide the optical fibers being connected within optical connecting device 200. The main body includes at least one widened area or opening 214a, 214b (collectively 214) formed along the top of the channel to accommodate mechanical element 260 and the actuation caps 250, 250′ at least partially within channel. In an exemplary embodiment shown in FIG. 4B, the main body includes two elongated openings 214a, 214b formed along the centerline of the channel to allow the actuation elements to be disposed over and adjacent to the gripping portions 260a, 260b of the mechanical element. The mechanical element can be held within the housing by either an interference fit or via mechanical means such as by anchoring the end portions of at least one of the plate-like members of the mechanical element retained by clearance fit below one or more overhanging tabs (not shown) provided within the channel 209.

Once mechanical element 260 is installed in housing 210, a first actuation cap 250 can be placed over the first gripping portion of mechanical element through opening 214a. Similarly, second actuation cap 250′ can be placed over the second gripping portion of the mechanical element through opening 214b.

The actuating caps are described with respect to FIG. 4C. FIG. 4C is an isometric bottom view of actuating cap 250. Actuating cap 250 includes a main body portion 252 that extends along a length of the cap. The main body includes two side walls 253 configured to extend down over the sides of the gripping portion of the mechanical element. Each side wall has an interior cam surface 254. The cam surfaces on the interior of the side walls of the actuation gap have a first portion near the top of the main body wherein the cam surfaces of the first portions are closer to one another than at a second portion near the edges of the side walls. There is a sloped transition portion between the first and second portions of the cam surface to aid the cap in sliding down over the mechanical gripping element when actuated. When the actuating cap is pushed down toward the mechanical gripping element, the legs of the mechanical gripping element slide along the transition portion such that the transition portion pushes the legs of the gripping element towards each other to a closed position to secure an optical fiber passing at least partially through the mechanical gripping element.

In addition, actuation cap 250 can include a plurality of extensions 255 extending from the sidewalls of the cap. The extensions serve as guides that aid in aligning the cap as it is inserted into the cavity within the main body of the exemplary optical connecting device. In an exemplary aspect one or more of the extensions can have a lip 255a protruding from a surface of the extension to secure the actuation cap within the optical connecting device after actuation to secure than optical fiber within the mechanical gripping device.

In one exemplary aspect, the main body can be configured to allow for the removal of the actuation caps to allow opening of the gripping portions of the mechanical elements so that the bare glass portion of the optical fiber can be repositioned or removed from the mechanical element. For example, the main body 210 can include at least one slot (not shown) that is accessible outside of the main body that allows the insertion of a tool to push the extensions 255 on the actuation cap upwards to at least partially release the gripping portion of the mechanical element allowing the legs of the mechanical element to separate, thus permitting removal and/or repositioning of the bare glass portion of at least one optical fiber disposed in the mechanical element.

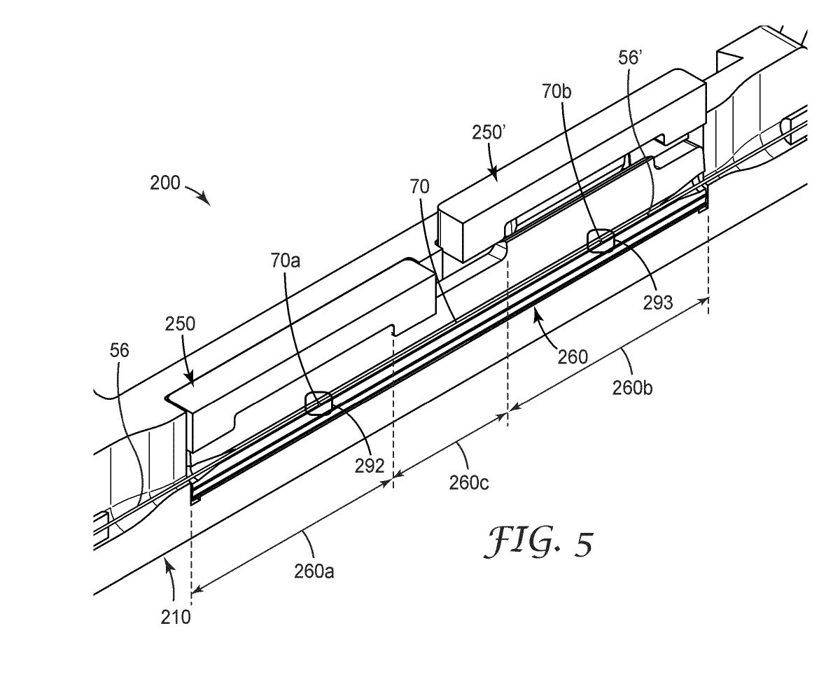

FIG. 5 is a partial cross section of optical fiber connecting device 200 showing the optical connection interfaces between the sensored optical fiber stub 70 and the bare glass portions 56, 56′ of two optical fibers being connected by the device in mechanical element 260. In this aspect, the connecting device includes sensored optical fiber stub 70 having a first end 70a and a second end 70b fixed in the fiber holding portion 260c of the mechanical element 260, such that the first end of the fiber stub extends into the first gripping portion 260a of the mechanical element and the second end of the fiber stub extends into the second gripping portion 260b of the mechanical element. Thus, the bare glass portion 56 of the first optical fiber 50 can be inserted into the first end of the main body and into the first gripping portion of the mechanical element until resistance is felt and the fiber begins to bow when the terminal end of the first optical fiber abuts against the first end of the optical fiber stub that is installed in the connection device. The first actuation cap 250 can be depressed to anchor the first optical fiber in the connection device to optically connect the first optical fiber with the optical fiber stub (depicted in highlight frame 292). Then, the bare glass portion 56′ of the second optical fiber 50′ can be inserted into the main body and into the second gripping portion of the mechanical element until resistance is felt and the fiber begins to bow when the terminal end of the second optical fiber abuts against the second terminal end of the optical fiber stub. The second actuation cap 250′ can be depressed to anchor the second optical fiber in the connection device optically connecting the second optical fiber and the optical fiber stub (depicted in highlight frame 293). In an exemplary aspect, the sensored optical fiber stub can have a Bragg grating formed in the core of the fiber stub to form a sensor and/or can have a thin film filter disposed on one of the first and/or second ends of the sensored optical fiber stub.

In operation, the actuation caps 250, 260 can be moved from an open position to a closed position (e.g. downward in the embodiment depicted in FIG. 4A). The cam surfaces on the interior of the actuating cap can slide over legs of the mechanical gripping element, urging the legs toward one another to secure the bare glass portion of the optical fiber between them. In particular, the bare glass portion(s) of the optical fiber(s) are held in grooves formed on the interior surface of the legs of the in the mechanical gripping element.

Housing 210 of optical fiber connecting device 200 can further include a first clamping portion 220 disposed at a first end 210a of the housing and second clamping portion 225 formed at a second end 210b of the housing opposite the first clamping portion. Thus, the mechanical elements 260 lies between the first and second clamping portions so that the first and second clamping portions can provide strain relief for the first and second optical fibers 50, 50′ disposed within the exemplary connection device.

Each clamping portion comprises a clamp mechanism as illustrated in FIG. 4D. For example clamp mechanism can be an alligator-style clamping mechanism. The clamp mechanism includes a base portion 216 which is integrally formed with the main body 212 of the housing 210, and a cover 224 which is rotatably connected to the base. Clamping mechanism 220 also includes locking features such as a catch 224a and a latch 218 that cooperate to secure the clamping mechanism in a closed position, thus anchoring the optical fibers being optically mated in the exemplary connection device. For example, the first end of 210a of optical fiber connecting device 200 includes a pair of latches 218 (only one is shown in the figure) disposed on either side of housing 210 and a pair of catches disposed on either side near the free end of the cover. In an alternative aspect the catches can be formed on the housing and the latches formed on the cover. The securing features described herein are only exemplary. One of ordinary skill in the art could easily derive other securing features to secure the clamping mechanism in a closed state.

As mentioned, cover 224 is rotatably attached to housing by a pivot hinge comprising a pair of pegs 217 disposed on either side of housing 210 and a pair of sockets 223 disposed on either side of the cover. The sockets can be in the form of an opening that extends through the sidewalls of the cover or a depression formed on the inside of the cover sidewalls. The diameter of the sockets will be slightly larger than the diameter of the pegs which fit into them to allow for smooth rotation of the cover from an open to a closed position.

The cover 224, 229 and/or the base portions 216 of each clamping mechanisms 220, 225 can include a plurality of sharp ridges (e.g. ridges 221 shown on the inside surface of cover 224 in FIG. 4D) which can bite into the coating surrounding the bare glass portion of the optical fiber whether it be a cable jacket material, a buffer tube through which the optical fiber passes or a buffer coating formed on the optical fiber.

Advantageously, optical fiber connecting device 200 can also include an auxiliary strength member gripping features. For example, the optical fiber connecting device 200 can include a trough 211 formed in the base portions 216 of the clamping mechanisms 220 and buttresses 224b formed on the cover 224 of the clamping mechanism, shown in FIG. 4D, can be used to trap Kevlar, glass fiber or other flexible strength member materials within the clamping mechanism providing enhanced strain relief for optical fiber cabled utilizing these types of strength members.

Optical fiber connecting device can also include an integral coupling mechanism to couple a first optical fiber connecting device 200 to a second optical fiber connecting device. The coupling mechanism can comprise a first slot 284a formed on a first side of housing 210 near clamping portion 220 and a first dovetail protrusion 282a formed on a first side of the housing 210 near clamping portion 225 that mate with a corresponding features on a second optical fiber connecting device. The dovetail protrusions are configured to slidingly and snugly engage the slots to connect two or more exemplary optical fiber connecting devices in a linear array. The integral coupling mechanism can comprise other known mechanical interlocking features that mate via a snap or interference fit.

FIGS. 6A and 6B show a third embodiment of an exemplary optical fiber connecting device 300 having an integral sensored fiber stub. Optical fiber connecting device 300 is substantially the same as exemplary optical fiber connecting device 200 shown in FIGS. 4A-4D, except that mechanical element 260 has been replaced by two separate mechanical elements 360, 360′ in device 300.

Optical fiber connecting device 300 includes a housing 310 having a first end 310a and a second end 310b and a channel 309 extending longitudinally through the main body from a first end of the main body to a second end of the main body to guide the optical fibers being connected within optical connecting device 300. The main body includes at least one widened area or opening 314a, 314b formed along the top of the channel to accommodate the first and second mechanical elements 360, 360′ and the actuation caps 350, 350′ at least partially within channel. In an exemplary embodiment shown in FIG. 6A, the main body includes two elongated openings 314a, 314b formed along the centerline of the channel to allow the first and second actuating caps to be disposed over and adjacent to the first and second mechanical elements. Specifically the first mechanical element 360 is disposed in the first opening 314a in the housing and the second mechanical element 360′ is disposed in the second opening 314b in the housing. The mechanical elements can be held within the housing by either an interference fit or via mechanical means such as by anchoring the end portions of at least one of the plate-like member of each mechanical element below one or more overhanging tabs (not shown) provided within the channel 309.

Once the first and second mechanical elements are installed in housing 310, a first actuation cap 350 can be placed over the first mechanical element through opening 314a, and the second actuation cap 350′ can be placed over the second the mechanical element through opening 314b.

Sensored optical fiber stub 70 having a first end 70a and a second end 70b is positioned within the housing 310 of the optical fiber connecting device 300 such that the first end of the fiber stub extends partially within the first mechanical element 360 and the second end of the fiber stub extends partially within the second mechanical element 360′ as shown in FIG. 6B. Thus, the bare glass portion 56 of the first optical fiber 50 can be inserted into the first end of housing 310 and into the first mechanical element until resistance is felt and the fiber begins to bow when the terminal end of the first optical fiber abuts against the first end of the optical fiber stub that is installed in the connection device. The first actuation cap 350 can be depressed to anchor the first optical fiber in the connection device such that it is optically connected to the first end of sensored optical fiber stub (depicted in highlight frame 392). Then, the bare glass portion 56′ of the second optical fiber 50′ can be inserted into the second end of the connection device and into the second mechanical element until resistance is felt and the fiber begins to bow when the terminal end of the second optical fiber abuts against the second terminal end of the sensored optical fiber stub. The second actuation cap 350′ can be depressed to anchor the second optical fiber in the connection device so that it is optically connecting to the second end of the sensored optical fiber stub (depicted in highlight frame 393). In an exemplary aspect, the sensored optical fiber stub can have a Bragg grating formed in the core of the fiber stub to form a sensor and/or can have a thin film filter disposed on one of the first and/or second ends of the sensored optical fiber stub.

Exemplary connecting devices 200, 300 is a new form of connecting device that allows direct connection of two optical fibers with and integrated sensor in a single compact device. These connecting devices can be considered an optical fiber splice device having an integrated sensor.

A plurality of optical fiber connecting devices 100, 200, 300 can be assembled together to form an optical fiber connecting device module. For example, a plurality of optical fiber connecting devices 100 can be attached to a module frame or a module base plate (not shown) to create an optical fiber connecting device module comprising these devices.

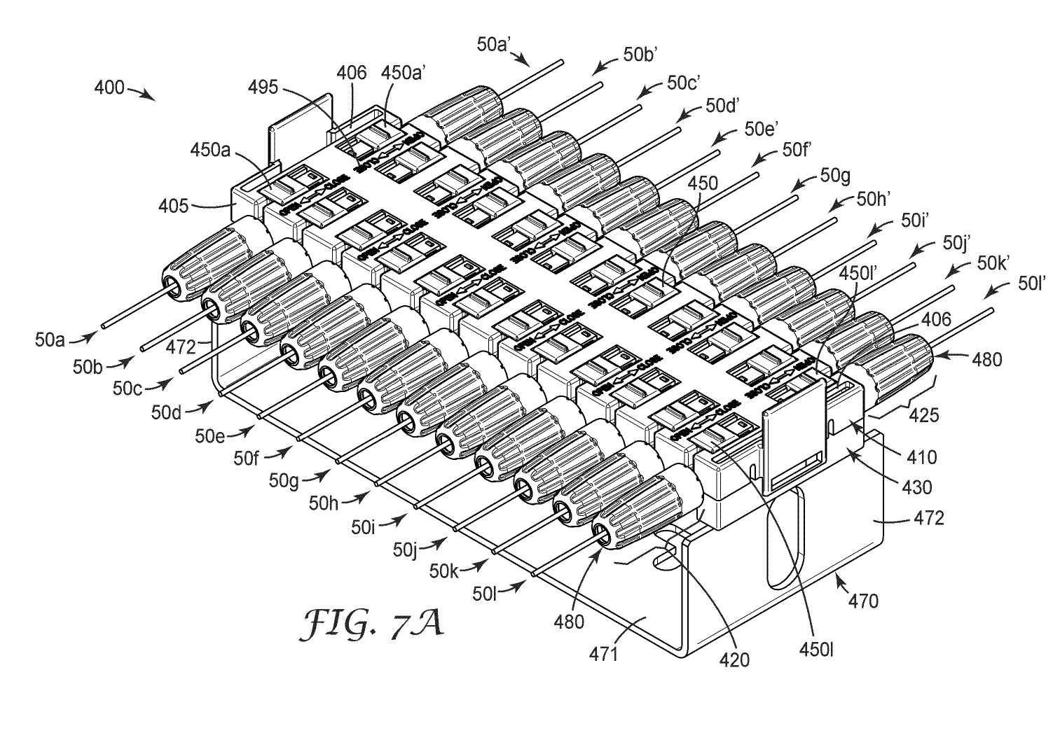

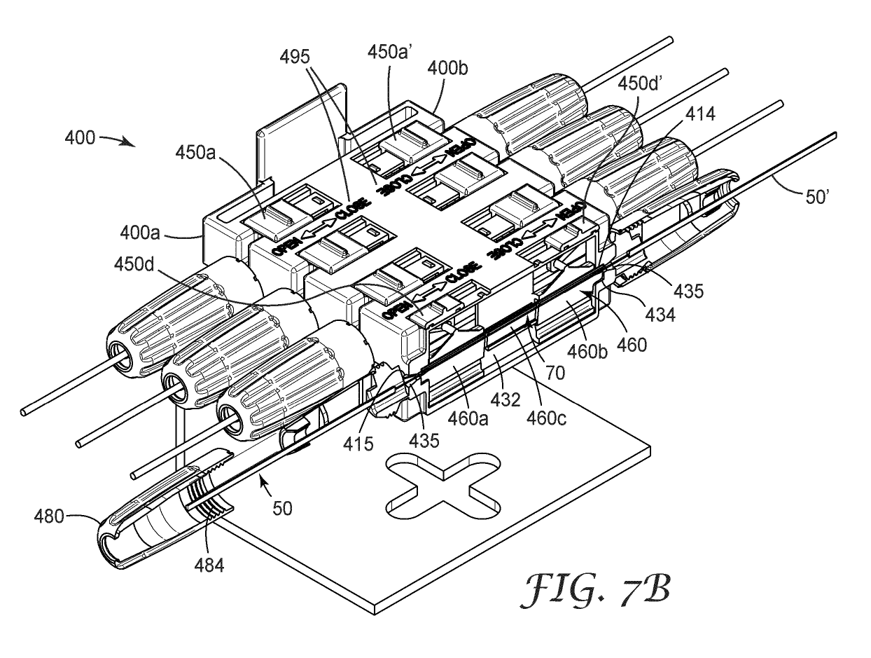

FIGS. 7A and 7B shows an alternative optical fiber connecting device module 400.

Exemplary optical fiber connecting device module 400 for independently securing a plurality of pairs of optical fibers 50a . . . 501, 50a′ . . . 501′. Optical fiber connecting device 400 includes a main body or housing 405 has a first side 400a and a second side 400b and is made up of an upper housing portion 410 and a lower housing portion 430 that can be secured together. The upper housing portion and a lower housing portion are configured to contain a plurality of mechanical elements 460, a plurality of first actuation mechanisms 450a . . . 4501 (collectively first actuation mechanisms 450), and a plurality of second actuation mechanisms 450a′ . . . 4501′ (collectively second actuation mechanisms 450′). Mechanical element 460 is the same as mechanical element described with respect to FIGS. 2A-2E and analogous numbers are used in the description below. The first and second actuation mechanisms can have the same structure, which is similar to the structures of first actuation mechanism 150 and second actuation mechanism 150′ described previously with respect to FIGS. 1A-1D. The first and second actuation mechanisms allow the gripping sections 460a, 460b of the mechanical element to be actuated separately. The mechanical element can be opened and closed a plurality of times by the actuation mechanism allowing the first and second optical fibers to be positioned, secured and actuated in the mechanical element at the same or different times.

To accommodate the plurality of mechanical elements and associated actuation mechanisms, lower housing portion 430 has a plurality of parallel channels (not shown) extending through the lower housing portion from the first side 400a of the housing 405 to the second side 400b of the housing to guide the optical fibers being connected by each of the plurality of mechanical elements in exemplary optical fiber connecting device module 400. At least one cavity 432 can be formed along the channel within the lower housing portion to at least partially accommodate the mechanical element 460 and a pair of actuation mechanisms such as actuation mechanisms 450d and 450d′ shown in FIG. 7B, which is a sectional view of the module cut along the longitudinal axis of one of the channels in the exemplary module. Half funnel guide structures 415, 435 are formed in the channel on either side of the cavity to facilitate guiding the bare glass portions of the optical fibers into the mechanical element. The mechanical element is held stationary in the housing of the module by opposing element holding notches 414, 434 formed in the upper and lower housing portions 410, 430, respectively, at each end of the cavity.

Each mechanical element can receive the bare glass portions of the first and second optical fibers 50 and 50′, so that the ends of the bare glass portions are butted against each end of a fiber stub 70 secured in the a fiber stub holding section 460c. The fiber stub holding section clamps on to the central portion of the fiber stub to secure the fiber stub in the mechanical element. The fiber stub is permanently secured in the mechanical element in the factory as described previously. In an exemplary aspect, fiber stub 70 is positioned in mechanical element 460 such that a first end of the fiber stub is disposed in the first gripping section 460a, and the second end of the fiber stub is positioned in the second gripping section 460b as shown in FIG. 7B.

The fiber gripping sections 460a, 460b of mechanical element 460 can be actuated in either the factory and/or the field. The unique structure of optical fiber connecting device modules 400 allow the fiber gripping sections of the mechanical elements to be opened and closed independently and reversibly by the built in actuation mechanisms 450, 450′. The actuation mechanisms are in the form of a sliding switches as described previously with respect to actuation mechanisms 150, 150′. While actuation mechanisms 450, 450′ are shown having the form of a sliding switch, other actuation mechanisms are possible.

The exemplary optical fiber connection module can further include clamping portions that are integrally formed with the housing 405.

In an exemplary aspect, indicia 495 can be formed in the top surface of the upper housing portion 410 to indicate whether the mechanical elements contained within the housing 405 of the optical fiber connecting device is open or closed.

The exemplary optical fiber connecting device module can include separate clamping portions for each optical fiber to be terminated in the module. Lower housing portion 430 can further include a plurality of first and second cable jacket clamping portions 420, 425 integrally formed with lower housing portion and disposed on either side of the mechanical element. Thus, the lower housing portion can be a unitary structure configured to house the mechanical element (with the upper housing portion) as well as providing the basic structure (e.g. the clamping portions) necessary to retain and provide strain relief for the first and second optical fibers 50, 50′ in the optical fiber connecting device. Each of the first cable jacket clamping portions 420 is configured to clamp the jacketed portion of one of the first optical fiber 50 and each of the second cable jacket clamping portions 425 is configured to clamp the jacketed portion of the second optical fiber 50′. In an alternative embodiment, the first and second cable jacket clamping portions can each be configured to clamp the outer surface of a buffer tube (not shown) containing the first and second optical fibers, respectively.

In an exemplary embodiment, the first and second cable jacket clamping portions 420, 425 can have the same basic structures. For example, each of the first and second cable jacket clamping portions can have a collet-type, split body shape comprising a pair of arms that extend away from the lower housing portion along a common axis as described previously with respect to cable jacket clamping portions 120, 125 shown in FIGS. 1A-1D.

A boot 480 can be utilized to actuate each of the plurality of clamping portions 420, 425 when secured to the optical fiber connecting device module 400. In an exemplary aspect, each boot can be attached to the clamping portion by a screw-type mechanism. When working with optical fiber cables having strength members, especially Kevlar or glass floss strength members, the boots can be used to clamp the fiber strength members as well as the fiber jackets of the first and second optical fibers to improve the retention strength of the optical fiber cables in the optical fiber connecting device.

In an exemplary aspect, optical fiber connecting device module 400 can be attached to a module frame 470. The module frame can be a one-piece elongated metal frame having a base 471 and two sides 472 connected to the base along one edge. Optical fiber connecting device module 400 can be attached to the module frame by a tongue (not shown) that extends from the top of each of the two sides and that is inserted into slots 406 formed in the housing 405 of the module.

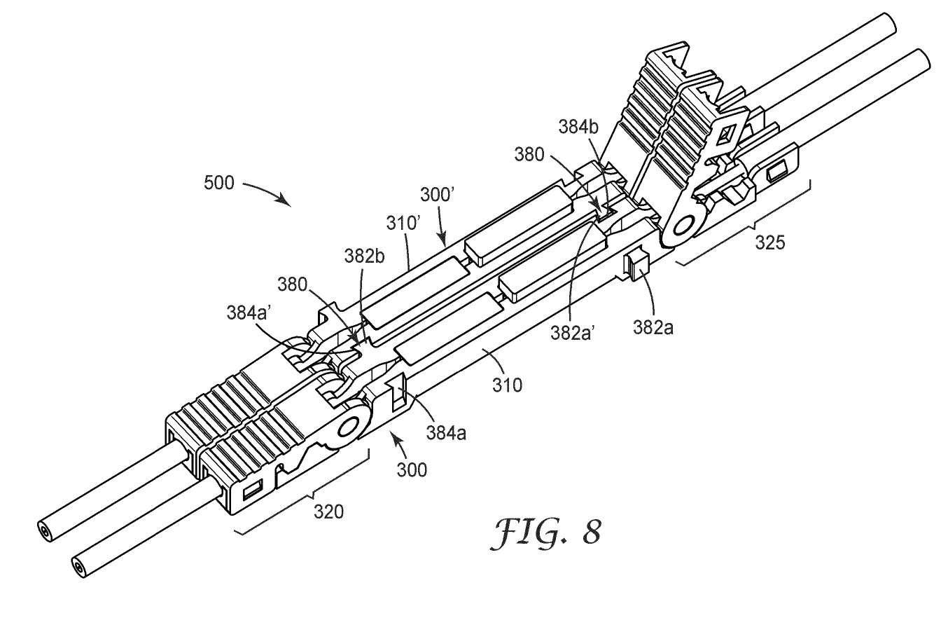

FIG. 8 shows another exemplary embodiment of an optical fiber connecting device module 500 formed by assembling a pair of optical fiber connecting devices 300, 300′ to one another with coupling mechanisms 380 that are integrally formed with the housing 310, 310′ of each device. For example, the coupling mechanism can comprise a first slot 384a formed on a first side of housing 310 near clamping portion 320 and a first dovetail protrusion 382a formed on a first side of the housing near clamping portion 325 and a corresponding second slot 384b formed on an opposite side of the housing across from the first dovetail protrusion and a second dovetail protrusion 382b disposed on an opposite side of the housing from the first slot. The dovetail protrusions are configured to slidingly and snugly engage the slots and dovetails of other optical fiber connecting devices to connect two or more exemplary optical fiber connecting device in a linear array.

Thus, optical fiber connecting devices 300, 300′ are attached to one another by sliding dovetail protrusion 382a′ of device 300′ into slot 384b of device 300 and dovetail protrusion 382b of device 300 into slot 384a′ of device 300′ until the dovetail protrusions are fully seated in the slots. Additionally, the integral coupling mechanism can comprise other known mechanical interlocking features that mate via a snap or interference fit.

Additional optical fiber connecting devices can be added to the module in a similar manner to create modules having different connection capacities.

The exemplary optical fiber connecting devices can be used as a single stand-alone device or in a module configuration in fiber to the home fiber cabinets or enclosures; optical fiber wall boxes, cabinets, equipment rooms, or enclosures in premises optical networks; high density optical distribution frames in data centers or telecommunication central offices; high density patch panels in mobile switching centers, enclosures for fiber to the antenna installations and in small cell aggregation point and back haul enclosures in wireless networks.

In one exemplary aspect, the optical connecting devices and modules described herein can be used in PON monitoring and point to point communication. For example, a central office can transmit an optical signal that includes a system signal and a monitoring signal. The signal is split at the cabinet location and distributed to end users, such as single family homes and buildings (e.g., multi-dwelling units). Optical connecting devices that include the wavelength selective stub fiber can be used not only for termination (connectorization) of optical fibers, but also for interconnection and cross connection in optical fiber networks inside a fiber distribution unit at an equipment room or a wall mount patch panel, inside pedestals, cross connect cabinets or closures or inside outlets in premises for optical fiber structured cabling applications, and can provide reflection of the monitoring signal at that particular location. This system can enable the network operator to determine fault location or line degradation for a specific subscriber ID, for example, based on a signal comparison against an initial installation performance state.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical fiber connecting device for housing a mechanical element for aligning, gripping, and connecting first and second optical fibers, each optical fiber including a bare glass portion surrounded by a buffer layer, the device comprising:
a housing configured to contain a mechanical element disposed therein,
an integrated optical fiber sensor at least partially disposed in the mechanical element, wherein the mechanical element optically connects at least one of the first and second optical fibers to the integrated optical fiber sensor, and
an actuation mechanism that opens and closes the mechanical element a plurality of times, and that allows for the first and second optical fibers to be positioned, secured and actuated in the mechanical element at the same or different times.

2. The device of claim 1, wherein the integrated optical fiber sensor is a fiber stub having at least one sensor element.

3. (canceled)

4. The device of claim 2, wherein the mechanical element comprises a first gripping section, a second gripping section, and a fiber stub holding section disposed between the first gripping section and the second gripping section, wherein the fiber stub extends through the fiber stub holding section and partially into the first and second gripping sections and wherein the bare glass portion of the first optical fiber connects to the first end of the fiber stub in the first gripping section and the bare glass portion of the second optical fiber connects to the second end of the fiber stub in the second gripping section.

5. The device of claim 4, comprising a first actuation mechanism positioned over the first gripping section of the mechanical element to open and close the first gripping section repeatably and independently of the second gripping section, and a second actuation mechanism positioned over the second gripping section of the mechanical element to open and close the second gripping section repeatably and independently of the first gripping section.

6. The device of claim 2, wherein the optical fiber connecting device comprises a first mechanical element and a second mechanical element wherein the fiber stub extends partially into each of the first and second mechanical elements and wherein the bare glass portion of the first optical fiber connects to the first end of the fiber stub in the first mechanical element and the bare glass portion of the second optical fiber connects to the second end of the fiber stub in the second mechanical element.

7. The device of claim 6, comprising a first actuation mechanism positioned over the first mechanical element to open and close the first mechanical element repeatably and independently of the second mechanical element, and a second actuation mechanism positioned over the second mechanical element to open and close the second mechanical element repeatably and independently of the first mechanical element.

8. (canceled)

9. The device of claim 2, wherein sensor element of the fiber stub senses the presence of a connection between the first and second optical fibers.

10. (canceled)

11. The device of claim 1, wherein the actuation mechanism comprise an actuation sleeve disposed around at least a portion of the mechanical element and an actuation element to raise and lower the actuation sleeve within the housing to open and close at least a portion the mechanical element.

12. The device of claim 1, wherein the actuation mechanism is an actuation cap disposed over at least a portion of the mechanical element which actuates at least the portion of the mechanical element by pushing the actuation cap down, thereby securing the bade glass portion of one of the first and second optical fibers in the optical fiber connecting device.

13-15. (canceled)

16. The device of claim 1, further comprising a first fiber clamping portion on a first side of the housing and a second fiber clamping portion in the second side of the housing, wherein the first clamping portion is configured to clamp onto an outer surface of the first optical fiber and the second clamping portion is configured to clamp onto an outer surface of the second optical fiber.

17-23. (canceled)

24. An optical fiber connecting device module for interconnecting bare glass portions of a plurality of optical fibers, comprising:
a plurality of first mechanical elements arranged parallel to one another in a side-by-side arrangement;
a plurality of integrated optical fiber sensors at least partially disposed in the first mechanical elements, wherein each of the first mechanical elements optically connects at least one of the first and second optical fibers to the integrated optical fiber sensor; and
a plurality of actuation mechanisms that can actuate the plurality of first mechanical elements to allow for the first and second optical fibers to be positioned, secured and actuated in the optical fiber connecting device at the same or different times.

25. The module of claim 24, further comprises a module housing having at least one upper housing portion and at least one lower housing portion mated to the upper housing portion, wherein the plurality of actuation mechanisms and the plurality of first mechanical elements are disposed at least partially within the module housing.

26. (canceled)

27. The module of claim 25, wherein the at least one lower housing portion is a ganged housing portion that is configured to hold the plurality of first mechanical elements in a side-by-side configuration.

28. (canceled)

29. The module of claim 24, wherein each of the plurality of first mechanical elements comprises a first gripping section, a second gripping section, and a fiber stub holding section disposed between the first gripping section and the second gripping section, wherein the fiber stub extends through the fiber stub holding section and partially into the first and second gripping sections and wherein the bare glass portion of the first optical fiber connects to the first end of the fiber stub in the first gripping section and the bare glass portion of the second optical fiber connects to the second end of the fiber stub in the second gripping section.

30. The module of claim 29, comprising a first actuation mechanism positioned over the first gripping section of the first mechanical element to open and close the first gripping section repeatably and independently of the second gripping section, and a second actuation mechanism positioned over the second gripping section of the first mechanical element to open and close the second gripping section repeatably and independently of the first gripping section.

31. The module of claim 24, further comprising a plurality of second mechanical elements, wherein each of the plurality of second mechanical elements lies along a common fiber axis with a corresponding mechanical element of the plurality of first mechanical elements, wherein the plurality of integrated optical sensors extends between and into one of the plurality of first mechanical elements and one of the plurality of second mechanical elements.

32. The module of claim 31, wherein the bare glass portion of each first optical fiber connects to the first end of one of the plurality of the integrated optical sensors in one of the plurality of first mechanical elements and the bare glass portion of the each second optical fiber connects to the second end of one of the plurality of the integrated optical sensors in one of the plurality of second mechanical elements.

33. The module of claim 31, comprises a plurality of first actuation mechanisms positioned over the plurality of first mechanical elements to open and close each of the first mechanical elements repeatably and independently of the second mechanical elements, and a plurality of second actuation mechanism positioned over the plurality of second mechanical element to open and close each of the second mechanical elements repeatably and independently of the first mechanical elements.

34. The device of claim 24, wherein each of the plurality of actuation mechanisms comprises an actuation sleeve disposed around at least a portion of one of the plurality of first mechanical elements and an actuation element to raise and lower the actuation sleeve within the housing to open and close at least a portion of said first the mechanical element.

35. The device of claim 24, wherein each of the plurality of the actuation mechanism is an actuation cap disposed over at least a portion of each of the plurality of first mechanical elements which actuates at least the portion of the first mechanical element by pushing the actuation cap down, thereby securing the bare glass portion of one of the first and second optical fibers in the optical fiber connecting device.

36-37. (canceled)
